(19) United States
(12) Patent Application Publication
(10) Pub. No.: US 2021/0135409 A1
(43) Pub. Date: May 6, 2021

(54) RETRACTABLE CONNECTING CABLE AND A PLUG THEREOF

(71) Applicant: CHAN JUNG HSU, Taipei (TW)

(72) Inventor: CHAN JUNG HSU, Taipei (TW)

(21) Appl. No.: 16/673,985

(22) Filed: Nov. 5, 2019

(51) Int. Cl. H01R 13/72; H01R 31/06; H01R 35/04

(52) U.S. Cl. CPC H01R 13/72; H01R 35/04; H01R 31/06

(57) ABSTRACT

An automatic retractable connecting cable and an associated plug are disclosed which the retractable connecting cable has a first connector and a second connector mounted respectively at two ends of a cable and a coupler. The coupler is configured for retaining the first connector and the second connector which makes the first connector, the second connector and the cable connected in a pile. plug comprises a movable plug and an adapter. The movable plug as a plug pattern formed on a side of the movable plug, and a first interface is formed on another side of the movable plug. The plug pattern is configured for operatively coupled to a socket of a mobile device. The adapter is connected to the connecting cable, and comprises a second interface. The second interface is configured to connect the first interface, wherein the second interface is rotatable relatively to the first interface.

### FIELD OF THE INVENTION

The present invention relates to a charging cable structure, and more particularly to an improved retractable connecting cable and associated improved plug structure.

### BACKGROUND

The demand of portable charging apparatus or charging station are significantly increasing due to the popularity of the mobile devices. Many stores even have sockets that is specially designed for charging. However, because the model of the mobile devices is varying, people have to prepare their own charging cable.

The common problem is not everyone has a good habit or patient wrapping their connecting cable. Not only the potential problem of knotting but also contact failure to the connecting cable, if the connecting cable is not properly received or stored. In other words, properly wrapping the connecting cable is able to increase the life of the connecting cable.

Accordingly, there's a need for associate electronic peripheral manufacturers to develop a mean or device of a connecting cable that does not change the general use and is convenient retracting the connecting cable.

### SUMMARY OF THE INVENTION:

One aspect of the invention is to provide a connecting cable that is able to automatically retract without providing any external force.

According to an embodiment of the present invention, an automatic retractable connecting cable has a first connector and a second connector mounted respectively at two ends of a cable and a coupler. The coupler is configured for retaining the first connector and the second connector which makes the first connector, the second connector and the cable connected in a pile.

Another aspect of the invention is to provide an improved plug structure to the retractable connecting cable.

According to another embodiment of the present invention, a plug comprises a movable plug and an adapter. The movable plug as a plug pattern formed on a side of the movable plug, and a first interface is formed on another side of the movable plug. The plug pattern is configured for operatively coupled to a socket of a mobile device. The adapter is connected to the connecting cable, and comprises a second interface. The second interface is configured to connect the first interface, wherein the second interface is rotatable relatively to the first interface.

Accordingly, the connecting cable with improved plug structure is able to retain the cable and the connector together by a coupler as the connecting cable is retracted, which is able to avoid the problems of knotting and connection failure, and thus increases the life of the connecting cable.

### BRIEF DESCRIPTION OF THE DRAWINGS:

Embodiments of the invention are described in more detail hereinafter with reference to the drawings, in which:

FIG. 1 is an exemplary diagram illustrating a connecting cable retracted in a form of spiral shape in accordance with an embodiment of the preset invention;

FIG. 2 is an exemplary diagram illustrating the use of the connecting cable of FIG. 1;

FIG. 3 is an exemplary diagram illustrating an improved plug structure in accordance with an embodiment of the present invention;

FIG. 4 is an exemplary diagram the interface of the plug illustrated in FIG. 3; and

FIG. 5 is an exemplary diagram illustrating the interface of the plug in accordance with another embodiment of the present invention.

### DETAILED DESCRIPTION:

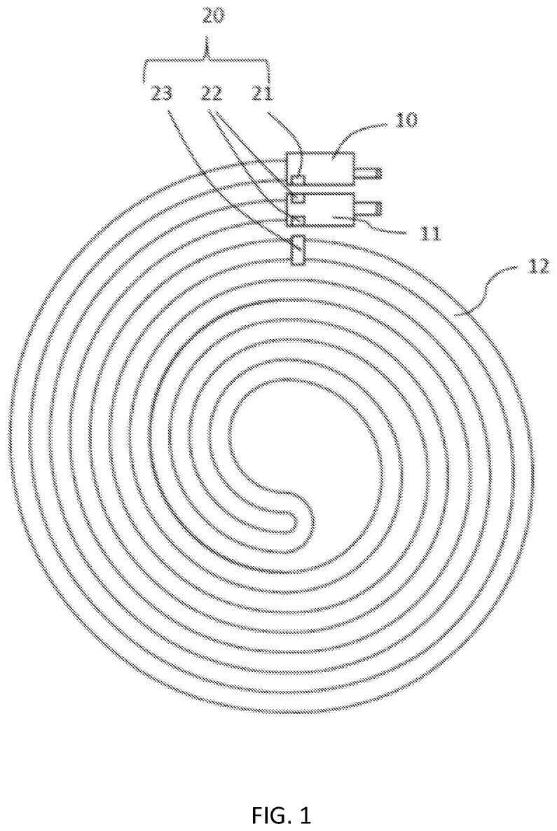

With reference to FIG. 1, FIG. 1 is an exemplary diagram illustrating a connecting cable retracted in a form of spiral shape in accordance with an embodiment of the preset invention. In this embodiment, the automatic retractable connecting cable has a first connector 10 and a second connector 11 mounted respectively at two ends of a cable 12. The cable 12 is able to automatically retracted itself without providing any external force. As shown in FIG. 1, the connecting cable comprises a coupler b 20. The coupler 20 is configured to retain the first connector 10 and the second connector 11. When the cable 12 is retracted in a form of spiral shape, the first connector 10 connects to the second connector 11 and the two connected connectors 10, 11 are then connected to the cable 12 in a pile.

With reference to FIGS. 1 and 2, FIG. 2 is an exemplary diagram illustrating the use of the connecting cable of FIG. 1. The coupler 20 comprises a first magnetic component 21, a second magnetic component 22 and a third component 23. The first magnetic component 21 is mounted on a position of the first connector 10. The second magnetic component 22 is mounted on a position of the second connector 11. The first magnetic component 21 and the second magnetic component 22 are attached when the cable 12 is retracted. The third magnetic component 23 is mounted on the cable 12 corresponding to the attachment position of the first connector 10 and the second connector 11. As shown in FIG. 1, when the connecting cable is retracted into the form of spiral shape, the third magnetic component 23 is configured to attach the second magnetic component 22 which makes the first connector 10 and the second connector 11 against the third magnetic component 23 adjacent to the cable 12.

In one embodiment, the install position of the third magnetic component 23 is adjustable to all different length of the cable, which is applicable in the productions of any specification of the connecting cable.

In one embodiment, the first magnetic component 21 comprises a second magnet mounted on a bottom surface of the first connector 10. The second magnetic component 22 comprises a first magnet and a second magnet. The first magnet is mounted on a top surface of the second connector. The second magnet 22 is mounted on a bottom surface of the second connector. The third magnetic component 23 comprises a first magnet mounted at a top surface of the cable. The first magnet and the second magnet have different magnetic properties, and the two attract each other.

In another embodiment, the differences are the locations of the first magnet and the second magnet. The first magnet may mount on the bottom surface of the first connector 10, the second magnets are mounted on two side of the second connector 11. The first connector 10 is attached to the second connector 11 against to the third magnetic component 23, which are retained adjacent to the cable 12.

In yet another embodiment, the first and second magnets are selectively mounted to the first and third magnetic component 21 and 23, and the second magnetic component 22 may be a metal element formed respectively on two sides of the second connector 11 or integrated as a one piece surround the second connector 11. As a person skilled in the art will realize that under the influence of magnetic fields of the first and second magnets, the metal element is still able to attach to the magnets.

Accordingly, the below table shows the combinations for configuring the first, second and third magnetic components:

| | Second magnetic | | |
|---|---|---|---|
| | component 22 | | |
| First magnetic | Top | Bottom | Third magnetic |
| component 21 | surface | surface | component 23 |
| The second | The first | The second | The first |
| magnet | magnet | magnet | magnet |
| The first | The second | The second | The first |
| magnet | magnet | magnet | magnet |
| The first | The second | The first | Metal element |
| magnet | magnet | magnet | |
| The first | The second | Metal element | The first |
| magnet | magnet | | magnet |
| The first | The second | Metal element | The second |
| magnet | magnet | | magnet |
| The first | Metal element | Metal element | The first |
| magnet | | | magnet |
| The first | Metal element | Metal element | The second |
| magnet | | | magnet |
| The first | Metal element | The first | The second |
| magnet | | magnet | magnet |
| The first | Metal element | The first | Metal element |
| magnet | | magnet | |
| The first | Metal element | The second | Metal element |
| magnet | | magnet | |
| The first | Metal element | The second | The first |
| magnet | | magnet | magnet |
| Metal element | The first | The first | The second |
| | magnet | magnet | magnet |
| Metal element | The first | The first | Metal element |
| | magnet | magnet | |
| Metal element | The first | The second | The first |
| | magnet | magnet | magnet |
| Metal element | The first | The second | Metal element |
| | magnet | magnet | |

Further, since the connecting cable of the present invention is retractable automatically into a form of spiral shape without providing any external force. The coupler used for retain the connectors is not limited to magnetic components, which it can also be achieved by other connection means such as buttons or Velcro. The reason that the connecting is able to retract into a spiral shape is because of that the cord of the connecting cable itself is pre-shaped. For example, the cord is inserted into a plastic tube first and heated to a spiral shape. The shaped spiral connecting cable is a stretchable cord as applying force onto it, and quickly recover its originally defined shape (i.e., spiral shape) when the force is disappeared.

Therefore, the drawback of this type of retractable connecting cable is the cord cannot self-rotate in 90 or 180 degrees. As shown in FIG. 2, the cable 12 of the retractable connecting cable occupies space at the back of the mobile device 40, which affects the efficiency of the space usage and the user experience.

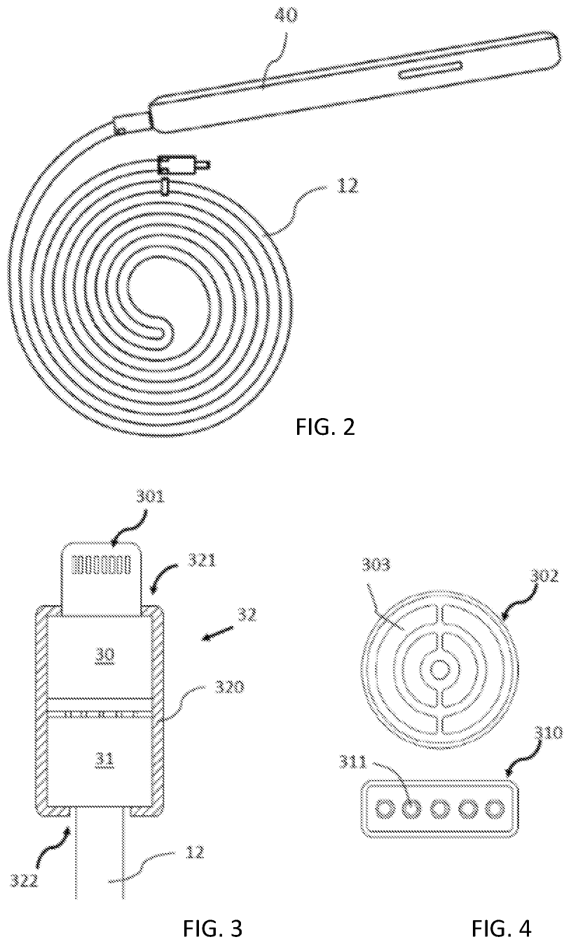

In order to solve above mentioned inconvenient, the present invention further improves the structure of the plug of the retractable cable. With reference to FIGS. 3 and 4, FIG. 3 is an exemplary diagram illustrating an improved plug structure in accordance with an embodiment of the present invention; and FIG. 4 is an exemplary diagram the interface of the plug illustrated in FIG. 3. In this embodiment, in this embodiment, the plug comprises a movable plug 30 and an adapter 31. The movable plug 30 has a plug pattern 301 and a first interface 302. The plug pattern 301 formed on a side of the movable plug 30, and is configured for operatively coupled to a socket/port of a mobile device.

The plug pattern 301 of the movable plug 30 is corresponded to the type of the socket of the mobile device, including but not limited to Type-C USB, Lightning and Micro USB.

The adapter 31 is connected to the cable 12, and comprises a second interface 310. The second interface 310 is configured to connect the first interface 302, wherein the second interface is rotatable relatively to the first interface. In an embodiment, the connection of the first interface 302 and the second interface 310 may accomplish by magnetic attachment or other mechanisms.

In an embodiment, the first interface 302 is a rounded plug structure, and has a water-ripple pattern plane electrode 303. The corresponding second interface 310 has a row of a pin electrode 311. The electrodes 303, 311 are composed of multiple metal contacts. The number of the metal contact is corresponding to the specification of the socket, in this embodiment, the electrodes 303, 311 are composed of 5 metal contacts.

As shown in FIG. 4, when the number of the metal contacts is even number, every two of the metal contacts are symmetrically and spaced outwardly arranging from a center of the first interface 302. The remaindered metal contact is placed at the center of the first interface 302. Each spaced contact is a curved (or circular arc) plane having approximately 179 degrees of angle corresponded to the remaindered metal contact as a common center. With similar manner, in another embodiment, when the number of the metal contacts is even number, there is no remaindered metal contact at the center of the first interface 302. The curved plane contact is symmetrically and spaced outwardly arranged on the first interface 302.

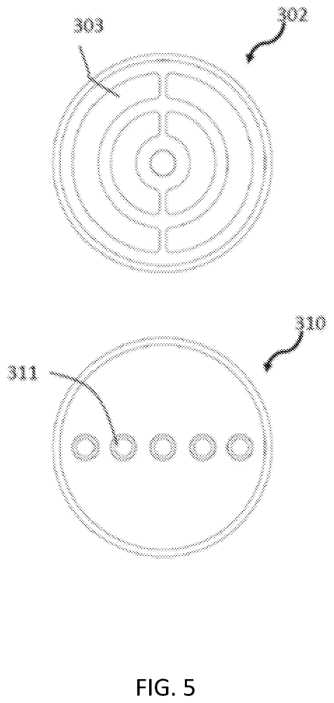

With reference to FIG. 5, FIG. 5 is an exemplary diagram illustrating the interface of the plug in accordance with another embodiment of the present invention. In this embodiment, both first interface 302 and second interface 310 are in a round plug structure, and have same outer diameter. Furthermore, the interface shown in FIGS. 4 and 5, the metal contact can be made from magnetic materials which allows the contacts respectively on the first interface 302 and the second interface 310 are able to magnetically attach together.

It is noted that the plane electrodes of the first interface and the pin electrodes of the second interface are exchangeable. In other words, the first interface may have the pin electrodes, and the second interface has the plane electrodes.

Moreover, in order to avoid the loosen situation during the rotation of the first interface and the second interface, the plug further comprises protecting mechanism 32. As shown in FIG. 3, in this embodiment, the protecting mechanism 32 has a sleeve 320. The sleeve 320 has a first opening 321 and a second opening 322 formed respectively at the two ends of the sleeve 320. The plug pattern 301 of the movable plug 30 is protruded from the first opening 321. The aperture of the second opening 322 is smaller than the width/diameter of the second interface, but is larger than the width/diameter of the cable 12. The sleeve 320 is configured to cover the movable plug 30 and the adapter 31. The length of the sleeve 320 is corresponding to the overall length of the connection of the first interface 302 and the second interface 310. The width of the sleeve 320 is silently larger than the width of the second interface 310 so that the second interface 310 is still able to rotate inside the sleeve 320 without the risk of loosen from the first interface 302.

Accordingly, the connecting cable with improved plug structure is able to retain the cable and the connector together by a coupler as the connecting cable is retracted, which is able to avoid the problems of knotting and connection failure, and thus increases the life of the connecting cable.

The foregoing description of the present invention has been provided for the purposes of illustration and description. It is not intended to be exhaustive or to limit the invention to the precise forms disclosed. Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. An improved retractable connecting cable having a first connector and a second connector mounted respectively at two ends of a cable, and being able to automatically retract the cable without providing any external force, the connecting cable comprising:
a coupler being configured for retaining the first connector and the second connector which makes the first connector, the second connector and the cable connected in a pile.

2. The connecting cable as claimed in claim 1, wherein the cable comprises
a first magnetic component mounted on the first connector;
a second magnetic component mounted on the second connector, wherein the first magnetic component and the second magnetic component are attached when the cable is retracted; and
a third magnetic component mounted on the cable corresponding to the attachment position of the first connector and the second connector, wherein the third magnetic component is configured to attach the second magnetic component which makes the first connector and the second connector against the third magnetic component adjacent to the cable.

3. The connecting cable as claimed in claim 2, wherein
the first magnetic component comprises a second magnet mounted on a bottom surface of the first connector;
the second magnetic component comprises
a first magnet mounted on a top surface of the second connector; and
a second magnet mounted on a bottom surface of the second connector; and
the third magnetic component comprises a first magnet mounted at a top surface of the cable, wherein the first magnet and the second magnet have different magnetic properties, and the two attract each other.

4. The connecting cable as claimed in claim 2, wherein the first magnetic component, the second magnetic component, and third magnetic component are attached to one and other by the magnetic attraction from magnets with two different properties or a magnet with a metal material.

5. A plug comprising:
a movable plug having
a plug pattern being formed on a side of the movable plug, and being configured for operatively coupled to a socket of a mobile device; and
a first interface being mounted on another side of the movable plug; and an adapter having
a second interface being formed on a side of the adapter, and being configured to connect the first interface, wherein the second interface is rotatable relatively to the first interface; and
a connecting cable being connected to another side of the adapter.

6. The plug as claimed in claim 5, wherein the first interface is a rounded plug structure, and has a plane electrode with the pattern of a water-ripple, which is composed of multiple metal contacts.

7. The plug as claimed in claim 6, wherein every two of the metal contacts are symmetrically and spaced outwardly arranging from a center of the first interface, and each spaced contact is a curved plane metal having approximately 179 degrees of angle.

8. The plug as claimed in claim 6, wherein the second interface has a row of pin electrode corresponded to the plane electrode of the first interface.

9. The plug as claimed in claim 5, wherein the connecting cable has a cable that is able to retract automatically without providing any external force, and the cable connected between a connector and the adapter, wherein a first magnetic component is mounted to the adapter, a second magnetic component is mounted to the connector, and the first magnetic component and the second magnetic component are attached when the cable is retracted.

10. The plug as claimed in claim 5, further comprising a sleeve configured for covering the movable plug and the adapter.

11. The plug as claimed in claim 10, wherein the sleeve has a first opening and the second opening formed respectively at the two ends of the sleeve, and the plug pattern of the movable plug is protruded from the first opening, wherein
the aperture of the second opening is smaller than the width of the second interface, but is larger than the diameter of the cable; and
the length of the sleeve is corresponding to the overall length of the connection of the first interface and the second interface, and the width of the sleeve is silently larger than the width of the second interface.

12. The plug as claimed in claim 5, wherein the movable plug and the adapter are magnet-attached.
